(19) United States
(12) Patent Application Publication
(10) Pub. No.: US 2022/0072855 A1
(43) Pub. Date: Mar. 10, 2022

(54) FIRING MASKS

(71) Applicant: Hewlett-Packard Development Company, L.P., Spring, TX (US)

(72) Inventors: Marta Blanch Pinol, Sant Cugat del Valles (ES); Diana Canto Estany, Sant Cugat del Valles (ES); Eduardo Amela Conesa, Sant Cugat del Valles (ES)

(73) Assignee: Hewlett-Packard Development Company, L.P., Spring, TX (US)

(21) Appl. No.: 17/419,061

(22) PCT Filed: Apr. 29, 2019
(86) PCT No.: PCT/US2019/029667

§ 371 Date: Jun. 28, 2021

(51) Int. Cl. B41J 2/045; B41J 2/21; G06K 15/10

(52) U.S. Cl. CPC B41J 2/04581; B41J 2/04551; G06K 15/107; B41J 2/0458; B41J 2/2132; B41J 2/04563

(57) ABSTRACT

A printing apparatus is disclosed. The printing apparatus comprises a printhead and a controller. The printhead includes an array of nozzles, each having an actuator to eject a printing fluid, the array of nozzles having a first and a second subset of nozzles, wherein the first subset is located at the vicinity of an edge of the printhead. The controller is to assign a firing mask so that the actuators corresponding to the first subset of nozzles are instructed to eject the printing fluid with a higher energy level than the actuators corresponding to the second subset of nozzles.

### BACKGROUND

Inkjet printers are systems that generate a printed image by propelling printing liquid through nozzles onto printing media locations associated with virtual pixels. The printing liquid drops may comprise pigments or dyes disposed in a liquid vehicle. In some examples, the printing fluid may be stored in a printing fluid container.

### BRIEF DESCRIPTION OF THE DRAWINGS

The present application may be more fully appreciated in connection with the following detailed description taken in conjunction with the accompanying drawings, in which like reference characters refer to like parts throughout and in which:

FIG. 1 is a block diagram illustrating an example of a printing apparatus.

FIG. 2 is a flowchart of an example method for determining firing masks.

FIG. 3A is a block diagram illustrating an example of a printhead and a firing mask.

FIG. 3B is a block diagram illustrating another example of a printhead and a firing mask.

FIG. 3C is a block diagram illustrating another example of a printhead and a firing mask.

FIG. 4 is a block diagram illustrating an example a printing apparatus.

FIG. 5 is a flowchart of an example method for modifying a firing mask.

FIG. 6 is a flowchart of an example of a method for defining a firing mask.

FIG. 7 is block diagram illustrating an example of a processor-based system to define a firing mask.

### DETAILED DESCRIPTION

The following description is directed to various examples of the disclosure. In the foregoing description, numerous details are set forth to provide an understanding of the examples disclosed herein. However, it may be understood by those skilled in the art that the examples may be practiced without these details. While a limited number of examples have been disclosed, those skilled in the art may appreciate numerous modifications and variations therefrom. It is intended that the appended claims cover such modifications and variations as fall within the scope of the examples. Throughout the present disclosure, the terms “a” and “an” are intended to denote at least one of a particular element. In addition, as used herein, the term “includes” means includes but not limited to, the term “including” means including but not limited to. The term “based on” means based at least in part on.

In the present disclosure reference is made to a printing system, printing apparatus, printing device, and/or printer. The terms “printing system”, “printing apparatus”, “printing device”, and/or “printer” should be read in their broad definition therefore being any image recording system that uses at least one printhead. In an example, the printing apparatus may be a two-dimensional (2D) desk printer. In another example, the printing apparatus may be a 2D large format printer. In another example, the printing apparatus may be a printing press, for example, an offset printing press. In yet another example, the printing apparatus may be a three-dimensional (3D) printer and/or an additive manufacturing system.

Some examples of printers comprise a plurality of nozzles distributed in a nozzle array across a single or a plurality of printheads, wherein each nozzle is assigned to a single printing fluid. In the present disclosure, the term “nozzle” should be interpreted as any cylindrical or round spout at the end of a pipe, hose, or tube used to control a jet of printing fluid.

The plurality of nozzles may eject a printing fluid. The printing fluid may also be referred herein as printing composition or water-based ink. In an example, the printing fluid may comprise a colorant and/or dye with a liquid carrier; e.g., cartridges and/or liquid toners. Some printing fluids may be dye based printing fluids, where dyes may be understood as a coloring solution. Other printing fluids may be pigment based printing fluids, where pigments may be understood as coloring particles in suspension. In another example the printing fluid may comprise ink particles and an imaging oil liquid carrier; e.g., liquid toner ink commercially known as HP Electrolnk from HP Inc. In another example, the printing fluid is an additive manufacturing fusing agent which may be an ink-type formulation comprising carbon black, such as, for example, the fusing agent formulation commercially known as V1Q60A “HP fusing agent” available from HP Inc. In an additional example such a fusing agent may additionally comprise an infra-red light absorber. In another additional example, such a fusing agent may additionally comprise a visible light absorber. In yet another additional example such fusing agent may additionally comprise a UV light absorber. Examples of inks comprising visible light enhancers are dye-based colored ink and pigment-based colored ink; e.g., inks commercially known as CE039A and CE042A available from HP Inc. In yet another example, the printing fluid may be a suitable additive manufacturing detailing agent; e.g., formulation commercially known as V1Q61A “HP detailing agent” available from HP Inc. A plurality of examples of the printing fluid that may be propelled by a nozzle has been disclosed, however any other chemical printing fluid comprising an agent in a liquid solvent or in a liquid carrier that may evaporate in contact with ambient air may be used without departing from the scope of the present disclosure.

Some examples of printheads span the full length of the printing media and may be fix with respect to a moveable printing media, these printheads may be referred hereinafter as fix printheads or page-wide printhead arrays. Other examples of printheads do not span the full length of the printing media. These printheads may scan throughout the width of the printing media, these printheads may be referred hereinafter as scanning printheads. A printing system may comprise fix printheads and/or scanning printheads, so that any location within the printing media may be printed thereon.

Some examples of fix printheads and scanning printheads may have thermal differences throughout the surface comprising an array of nozzles. For example, in use, the temperature in the middle of the printhead may be higher than the temperature at the edges of the printhead. This temperature gradient may be caused by convection with the air surrounding the edges of the printhead. In some examples, the temperature gradient may also be caused by airflows generated as a consequence of the movement of a scanning printhead or other elements within the printing system.

The temperature at a nozzle may have an effect in the Image Quality (IQ) of the recorded image (i.e., printed image) in the printing media. For example, a higher temperature at a nozzle may generate a larger (i.e., bigger in size) drop of printing fluid than the respective drop generated at the nozzle at a lower temperature. A larger drop may generate a darker recording image at the location in which the drop is poured onto with respect to a smaller drop. Therefore, a gradient temperature between a first location and a second location of the printhead, even when ejecting the same printing fluid, may cause a different color recording value or tone (e.g., different darkness and lightness values) which may be visible by the human eye. This effect may cause the so called dark light zone banding, referred hereinafter as banding. This type of banding may be visible at any viewing distance, thereby causing a poor IQ of the recorded image.

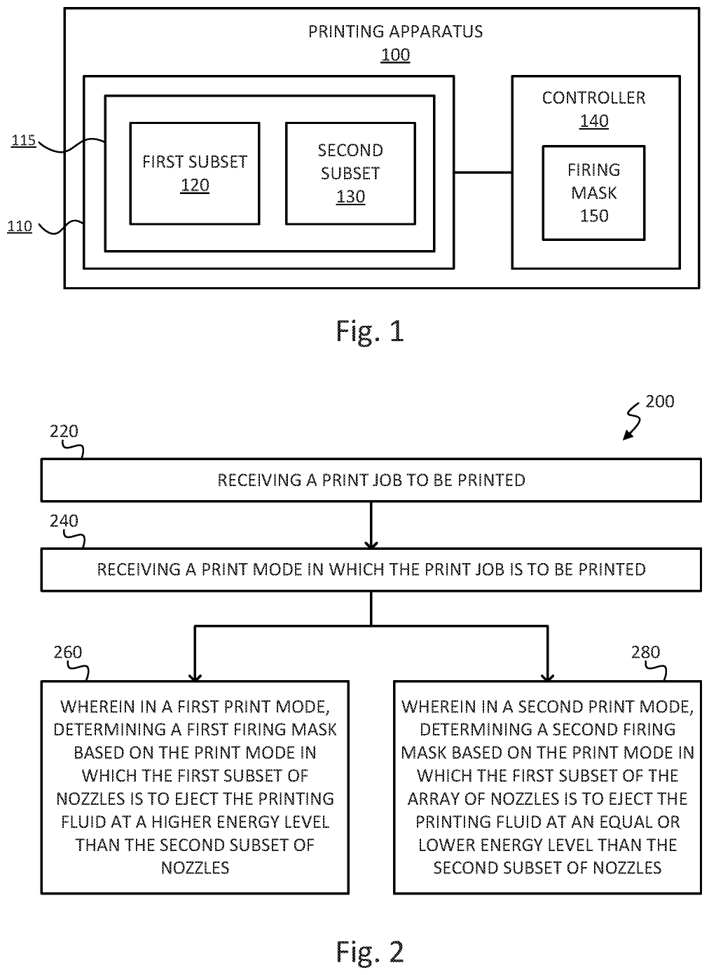

Referring now to the drawings, FIG. 1 is a block diagram illustrating an example of a printing apparatus 100. The printing apparatus 100 comprises a printhead 110 and a controller 140.

The printhead 110 includes an array of nozzles 115. Each nozzle from the array of nozzles 115 comprises an actuator (not shown) which ejects an amount of printing fluid through the respective nozzle. The actuator may vary depending on the printing technology from the printing apparatus 100. In an example, the printing apparatus 100 may be a thermal inkjet printer in which the actuator is a heating element. In thermal inkjet printers, each nozzle may be assigned to a heating element (i.e., actuator) that upon receiving an electric pulse, vaporizes an amount of the printing fluid. The vapor of the vaporized printing fluid bubbles out the nozzle and places a drop of the printing fluid on the printing media as the printhead scans across the surface. In another example, the printing apparatus 100 may be a piezoelectric printer, in which the actuator is a piezo crystal. In a piezoelectric printer, the piezo crystal vibrates rapidly upon receiving an electric signal. As the piezo crystal vibrates on the forward stroke of the vibration the crystal squeezes out a drop of printing fluid; and on the backward stroke, the crystal creates suction and draws ink into the nozzle.

The array of nozzles 115 comprises a first subset of nozzles 120 and a second subset of nozzles 130. In use, the temperature from the first subset of nozzles 120 may have a temperature gradient with respect to the temperature from the second subset of nozzles 130. In an example, the first subset of nozzles 120 may correspond to the nozzles located at the vicinity of an edge of the printhead 110, since when in use, these first subset of nozzles 120 may have a lower temperature than the other nozzles from the second subset of nozzles 120 located at the vicinity of the middle of the printhead 110. Additionally, the edge corresponding to the first subset of nozzles 120 may be an edge from the array of nozzles 115 which is parallel with respect to a printing scanning axis. Alternatively the edge corresponding to the first subset of nozzles 120 may be an edge from the array of nozzles 115 which is orthogonal with respect to a printing scanning axis. In another example, the first subset of nozzles 120 may correspond to the nozzles located at the vicinity of two opposite edges of the printhead 110. In yet another example, the first subset of nozzles 120 may correspond to the nozzles located at the vicinity of every edge of the printhead 110. In other examples, the first subset of nozzles 120 may be in any position within the printhead 110 that, when in use, has a lower temperature than the other nozzles within the printhead 110 (e.g., second subset of nozzles 120).

The printing apparatus 100 additionally comprises a controller 140. The controller 140 may be any combinations of hardware and programming that may be implemented in a number of different ways. For example, the programming of modules may be processor-executable instructions stored on at least one non-transitory machine-readable storage medium and the hardware for modules may include at least one processor to execute those instructions. In some examples described herein, multiple modules may be collectively implemented by a combination of hardware and programming. In other examples, the functionalities of the controller 140 may be, at least partially, implemented in the form of electronic circuitry.

The controller 140 is to assign a firing mask 150 so that the actuators (not shown) corresponding to the first subset of nozzles 120 are instructed to eject the printing fluid with a higher energy level than the actuators corresponding to the second subset of nozzles 130. As mentioned above, the actuator may vary depending on the printing technology used. In thermal inkjet, the actuator is a heating element that vaporizes printing fluid bubbles upon receiving an electric pulse. In piezoelectric technology, the actuator is a piezo crystal that vibrates upon receiving an electric signal. The controller 140 may instruct electric pulses or signals to control the actuators. The controller 140 may instruct electric pulses or signals based on the firing mask 150. In the examples herein, the energy level should be interpreted as the electric pulses or signals received by an actuator.

By increasing the energy level of an actuator, the usage of the nozzle associated with the actuator is increased and thereby the temperature of that nozzle may increase. Taken by the same token, increasing the energy level of the actuators associated with cold nozzles (e.g., first subset 120 of nozzles) may increase their temperature, thereby reducing the temperature gradient between the nozzles from the first subset 120 and the second subset 130. This may reduce the banding generated due to the temperature gradient across different nozzles from the printhead 110.

In the present disclosure, a firing mask should be interpreted as those instructions comprising the mapping of each actuator associated with a nozzle from the array of nozzles 115 (e.g., first subset 120 and second subset of nozzles 130) with the corresponding energy level, throughout the print job. For example, a firing mask (e.g., firing mask 150) may comprise instructions assigning the actuators corresponding to the first subset of nozzles 120 with a higher energy level, and instructions assigning the actuators corresponding to the second subset of nozzles 130 with a lower energy level.

In an example, the controller 140 is to define the firing mask 150 of the nozzles corresponding to the first subset 120 to assign a fire pulse frequency that comprises a value from a range defined from about 8 Hz to about 12 Hz, for example 10 Hz. In another example, the controller 140 is to define the firing mask 150 of the nozzles corresponding to the first subset 120 to assign a fire pulse frequency that comprises a value from a range defined from about 7 Hz to about 14 Hz, for example 9 Hz. In another example, the controller 140 is to define the firing mask 150 of the nozzles corresponding to the first subset 120 to assign a fire pulse frequency that comprises a value from a range defined from about 9 Hz to about 10 Hz, for example 9.5 Hz. In yet another example, the controller 140 is to define the firing mask 150 of the nozzles corresponding to the first subset 120 to assign a fire pulse frequency that comprises a value from a range defined from about 6 Hz to about 14 Hz, for example 10.5 Hz.

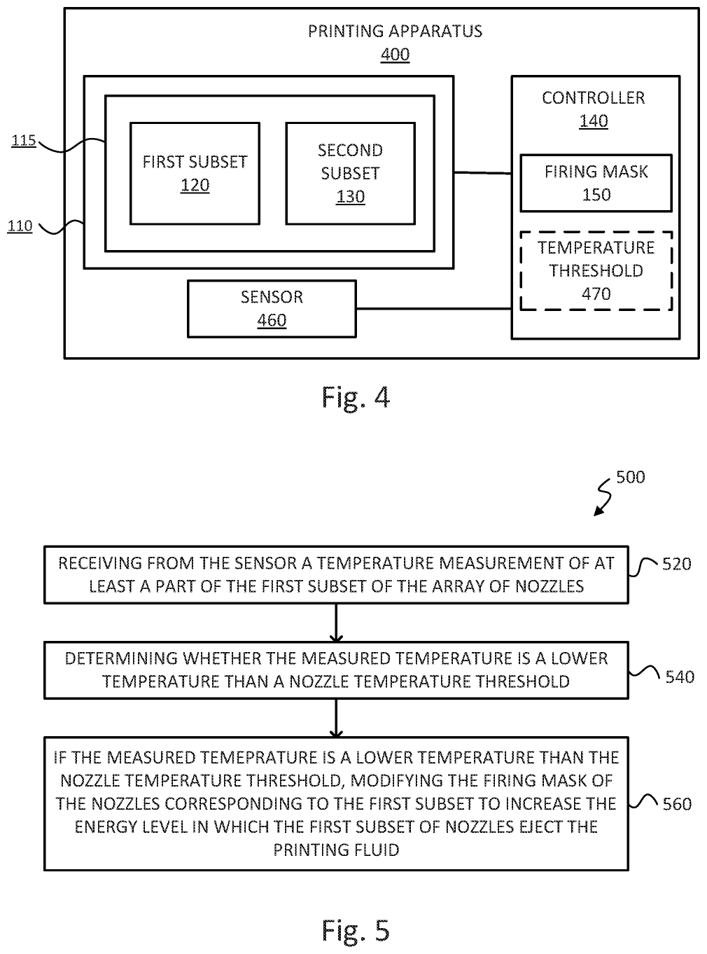

In other examples, the controller 140 may be to execute the method 200 of FIG. 2 for determining firing masks. Additionally or alternatively, the controller 140 may be to execute method 400 from FIG. 4 and/or method 500 from FIG. 5.

FIG. 2 is a flowchart of an example method 200 for determining firing masks.

At block 220 the controller (e.g., controller 140 from FIG. 1) may receive a print job to be printed. The print job comprises printing instructions to reproduce a physical printed product using the printing fluid associated with the printhead 110. The printhead 110 may selectively eject (i.e., propel) the printing fluid onto a printing media. Therefore, the print job comprises data including the location in which droplets of the printing fluid from the printhead 110 should be propelled.

At block 240, the controller may receive or determine a print mode in which the print job is to be printed. The print mode may be understood as the selection of the values of the parameters and/or features that may have an effect in the printing operation. In an example, the print mode may comprise at least one parameter of the group defined by ink efficiency, number of passes, printhead 110 or carriage scanning speed, drop volume, ink density, printhead nozzle resolution, or a combination thereof. The ink efficiency may be defined as the mass of the printing fluid to be set per surface unit, for example, about 10 grams per square meter (g/sqm). The number of passes may be used in, for example, large format printers that comprise a carriage 110 with a plurality of printheads 110 therein, in which different subsets of the printheads from the carriage may print different passes, for example, four or six passes. The carriage speed may be defined as the speed of the scanning printhead 110 from an edge of the width of the printing media to the opposite edge, for example, about 1016 millimeter per second (40 inches per second). The drop volume may be defined as the volume of each drop of the printing fluid in a spit, for example, about 12 picolitres (pl). The ink density may be defined as the mass of the printing fluid in a unity of volume, for example, about 1 gram per cubic centimeter (g/cc). The printhead nozzle resolution may be defined as the number of dots of the printing fluid in a unit of surface, for example, about 472 dots per centimeter (1200 dots per inch).

Additionally, the controller may receive further information associated with the print mode. In an example, the controller may receive an input indicative that the received print job to be printed is to be displayed outdoor or at a medium or long distance from the viewer. In this example, the controller may select the print mode as a first print mode (e.g., outdoor print mode). In another example, the controller may receive an input indicative that the received print job to be printed has high-quality requirements or that it is to be displayed at a short distance from the viewer. In this example, the controller may select the print mode as a second print mode (e.g., high quality print mode). In the examples herein, a medium distance should be interpreted as a distance of at least about one meter, a short distance as a shorter distance from about one meter, and a long distance as a longer distance from about one meter.

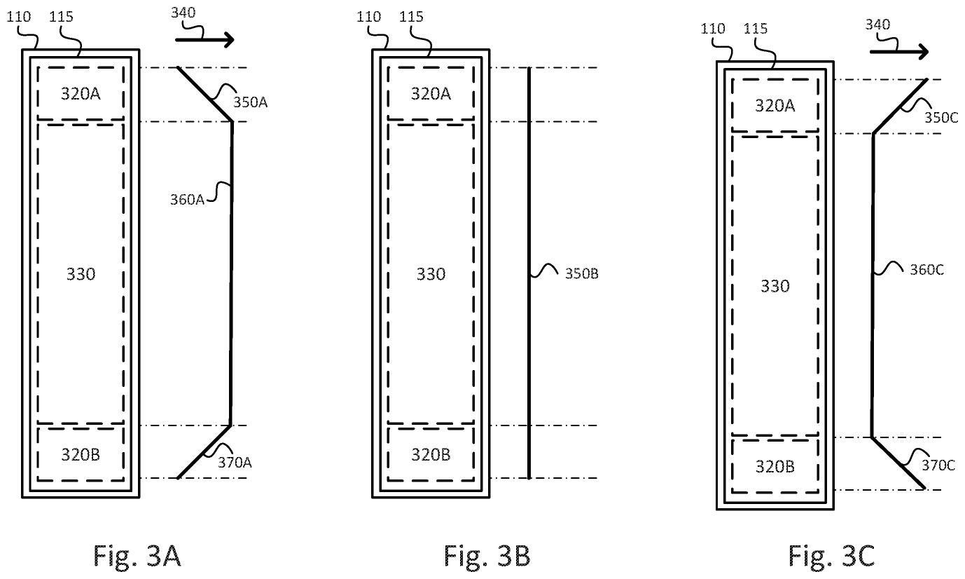

In an example, if the received print mode is a first print mode, at block 260 the controller is to determine a first firing mask 150 based on the print mode in which the first subset of nozzles 120 is to eject the printing fluid at a higher energy level than the second subset of nozzles 130. An example of the first firing mask 150 is disclosed below with reference to FIG. 3C.

In another example, if the received print mode is a second print mode, at block 280 the controller is to determine a second firing mask 150 based on the print mode in which the first subset of the array of nozzles 120 is to eject the printing fluid at an equal or lower energy level than the second subset of nozzles 130. Some examples of the second firing mask 150 are disclosed below with reference to FIGS. 3A and 3B.

FIG. 3A is a block diagram illustrating an example of a printhead 110 and a firing mask. In the example, the firing mask 150 is a ramp mask.

The printhead 110 comprises an array of nozzles 115. In the example, the array of nozzles has three parts, however the printhead in other examples may comprise more or less parts. The array of nozzles 115 comprises a first part 320A and a second part 320B corresponding to the edges of two opposite sides of a printhead 110, and a third part 330 in the middle of the printhead in between the first part 320A and the second part 320B. The first part 320A and the second part may comprise the nozzles corresponding to the first subset of nozzles (e.g., first subset of nozzles 120), and the third part 330 may comprise the nozzles corresponding to the second subset of nozzles (e.g., second subset of nozzles 130).

The firing mask is indicated as a thick solid line comprising a first segment 350A, a second segment 370A, and a third segment 360A. The first segment 350A is the part from the firing mask associated with the actuators corresponding to the nozzles from the first part 320A. The second segment 370A is the part from the firing mask associated with the actuators corresponding to the nozzles from the second part 320B. The third segment 360A is the part from the firing mask associated with the actuators corresponding to the nozzles from the third part 330.

The arrow 340 is indicative of the energy level associated with each part of the segments from the firing mask. The tip of the arrow indicates a higher energy level and the tail of the arrow indicates a lower energy level. In the example, the controller (e.g., controller 140 from FIG. 1) defined a firing mask so that the actuators corresponding to the nozzles from the third part 330 to receive a high energy level and thereby cause the nozzles to eject printing fluid at a higher frequency. In the example, the controller also defined the firing mask so that the actuators corresponding to the nozzles from the first part 320A and the second part 320B to receive a lower energy level and thereby cause the nozzles to eject printing fluid at a lower frequency than the nozzles corresponding to the third part 330. Additionally, this firing mask causes the nozzles from the first part 320A and the second part 320E that are in a further location from the third part 330 to eject printing fluid at a lower energy level than the nozzles from the first part 320A and second part 320B that are located closer to the third part 330, thereby generating a ramp along the nozzles corresponding to the first part 320A and the second part 320B. This firing mask may cause the printed parts to have a high quality and resolution.

FIG. 3B is a block diagram illustrating another example of a printhead 110 and a firing mask. In the example, the firing mask 150 is a square mask.

For simplicity, the printhead 110 comprises the same array of nozzles 115, first part 320A, second part 230B, and third part 330 as the example printhead 110 from FIG. 3A. However, other similar examples may comprise a different amount of parts.

The firing mask is indicated as a thick solid line comprising a single segment 350B. The single segment 350B is the part from the firing mask associated with the actuators corresponding to the nozzles from the first part 320A, second part 3208, and third part 330. In the example, the controller (e.g., controller 140 from FIG. 1) defined a firing mask so that the actuators corresponding to the nozzles from the first part 320A, second part 320B, and third part 330 to receive a similar energy level and thereby cause the nozzles across the array of nozzles 115 to eject printing fluid at a similar frequency. This firing mask may cause similar nozzle degradation throughout the nozzles in the array of nozzles 115.

FIG. 3C is a block diagram illustrating another example of a printhead 110 and a firing mask. In the example, the firing mask 150 is an inverted ramp mask.

The printhead 110 comprises an array of nozzles 115. In the example, the array of nozzles has three parts, however the printhead in other examples may comprise more or less parts. The array of nozzles 115 comprises a first part 320A and a second part 320E corresponding to the edges of two opposite sides of a printhead 110, and a third part 330 in the middle of the printhead in between the first part 320A and the second part 320B. The first part 320A and the second part may comprise the nozzles corresponding to the first subset of nozzles (e.g., first subset of nozzles 120), and the third part 330 may comprise the nozzles corresponding to the second subset of nozzles (e.g., second subset of nozzles 130). Thereby, when in use, the temperature on the nozzles from the first part 320A and the second part 320B may be lower than the temperature on the nozzles from the third part 330. This difference of temperature may cause different printing fluid drop size from the nozzles from the first part 320A and second part 320B compared to the printing fluid drop size from the nozzles from the third part 330. The difference in size of the printing fluid drop may cause banding.

The firing mask is indicated as a thick solid line comprising a first segment 350C, a second segment 370C, and a third segment 360C. The first segment 350C is the part from the firing mask associated with the actuators corresponding to the nozzles from the first part 320A. The second segment 370C is the part from the firing mask associated with the actuators corresponding to the nozzles from the second part 320B. The third segment 360C is the part from the firing mask associated with the actuators corresponding to the nozzles from the third part 330.

The arrow 340 is indicative of the energy level associated with each part of the segments from the firing mask. The tip of the arrow indicates a higher energy level and the tail of the arrow indicates a lower energy level. In the example, the controller (e.g., controller 140 from FIG. 1) defined a firing mask so that the actuators corresponding to the nozzles from the first part 320A and the second part 320B receive a high energy level and thereby cause the nozzles to eject printing fluid at a higher frequency. Firing printing fluid at a higher frequency causes the temperature from the nozzles from the first part 320A and the second part 320B to raise, and thereby to reduce the temperature gradient between the nozzles from the first part 320A and the second part 320E from the nozzles from the third part 330. In the example, the controller also defined the firing mask so that the actuators corresponding to the nozzles from the third part 330 to receive a lower energy level and thereby cause the nozzles to eject printing fluid at a lower frequency than the nozzles corresponding to the third part 330.

Additionally, this firing mask causes the nozzles from the first part 320A and the second part 320E that are located in a closer location from the third part 330 to eject printing fluid at a lower energy level than the nozzles from the first part 320A and second part 3208 that are located in a further location from the third part 330, thereby generating an inverted ramp along the nozzles corresponding to the first part 320A and the second part 320B. For the reasons above, this firing mask may cause the printed parts to be less likely to comprise banding (e.g., dark light zone banding).

FIG. 4 is a block diagram illustrating an example a printing apparatus 400. The printing apparatus 400 comprises a printhead 110 including an array of nozzles 115. The printhead 110 and the array of nozzles 115 may be the same as or similar to the references of elements from FIG. 1. The printing apparatus 400 also comprises a controller 140 to assign a firing mask 150 so that actuators corresponding to the first subset of nozzles 120 from the array of nozzles 115 are instructed to eject the printing fluid with a higher energy level than the actuators corresponding to a second subset of nozzles 130 from the array of nozzles 115. The controller 140, the firing mask 150, the first subset of nozzles 120 and the second subset of nozzles 130 may be the same as or similar to the corresponding numbered elements from FIG. 1.

The apparatus 400 also comprises a sensor 460. The sensor 460 may be any sensor suitable to determine a temperature associated with the first subset 120 of the array of nozzles 115. In some examples, the temperature associated with the first subset 120 is measured in the array of nozzles 115. In other examples, the temperature associated with the first subset 120 is measured at a location on the print zone associated with the first subset 120, for example, the location on the print zone in which the printing fluid ejected from the first subset of nozzles 120 is deposited. In an example, the sensor 460 is a point sensor thereby a sensor suitable to measure the temperature of a specific location of the print zone or the first subset 120. In another example, the sensor 460 is a sensor capable to measure the temperature of an area of the print zone or the first subset 120, for example a resistive temperature sensor an array of temperature sensors, a thermal camera, or the like.

Additionally, the controller 140 may also comprise a temperature threshold 470. The temperature threshold 470 may have been inputted externally (e.g., by a user, a driver an update) or may have been computed by the controller 140 itself. The temperature threshold 470 may be a pre-defined temperature associated with a temperature from the second subset of nozzles 130. The temperature threshold 470 may be defined as an allowed temperature gradient (e.g., difference of temperature) between the temperature from the first subset 120 that may have been previously measured by the sensor 460, and the temperature from the second subset 130. The temperature of the second subset 130 may be determined by the controller 140 based on for example at least one of the print mode, the print job, energy level used, and the like. The controller 140 may perform the method 500 from FIG. 5 to modify the print mask 150 using the sensor 460 and the temperature threshold 470.

FIG. 5 is a flowchart of an example method 500 for modifying a firing mask. As mentioned above method 500 may be executed by the controller 140.

At block 520, the controller (e.g., controller 140 from FIG. 4) may receive from a sensor (e.g., sensor 460 from FIG. 4) a temperature measurement of at least a part of a first subset of the array of nozzles (e.g., first subset 120 of the array of nozzles 115). The first subset of nozzles may be located at the vicinity of an edge of the printhead (e.g., printhead 110). In some examples, the temperature measurement may be a specific location measurement from the first subset. In other examples, the temperature measurement may be a measurement comprising an area comprising, at least part of the first subset of nozzles.

At block 540, the controller may determine whether the measured temperature is a lower temperature than a nozzle temperature threshold (e.g., temperature threshold 470 from FIG. 4). If the measured temperature is a lower temperature than the nozzle temperature threshold, at block 560, the controller may modify the firing mask (e.g., firing mask 150) of the nozzles corresponding to the first subset to increase the energy level in which the first subset of nozzles eject the printing fluid.

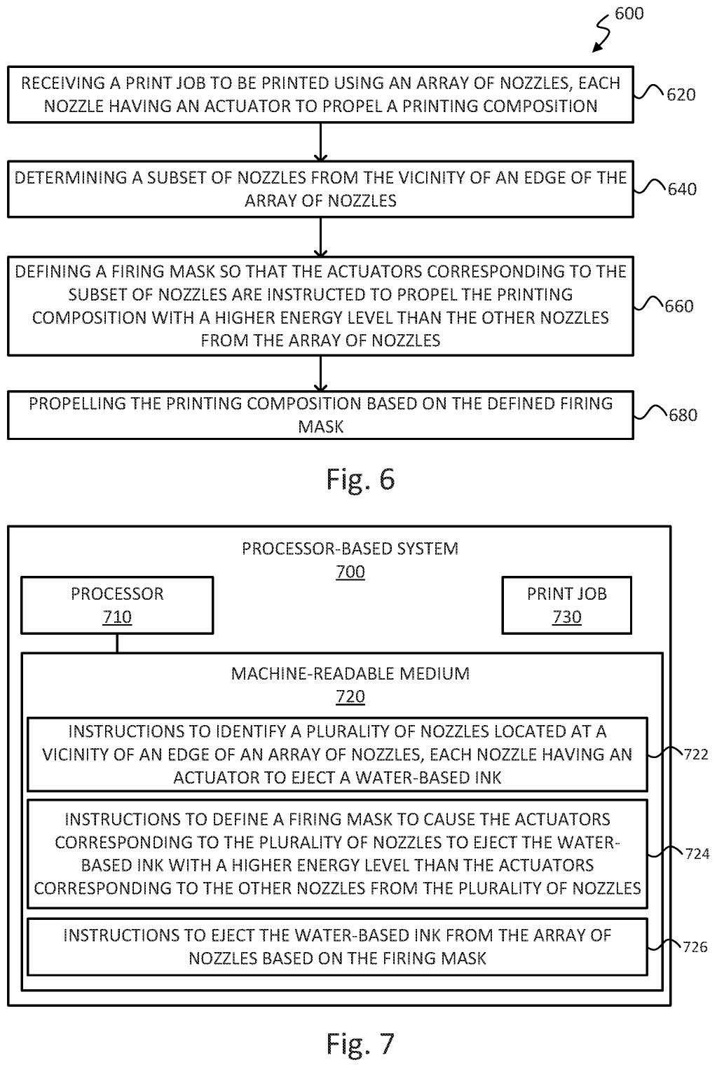

FIG. 6 is a flowchart of an example of a method 600 for defining a firing mask 150. As mentioned above, method 500 may be executed by the controller 140 from FIG. 1.

At block 620, the controller (e.g., controller 140) may receive a print job to be printed using an array of nozzles (e.g., array of nozzles 115), each nozzle having an actuator to propel a printing composition (e.g., printing fluid).

At block 640, the controller may determine a subset of nozzles (e.g., first subset 120) from the vicinity of an edge of the array of nozzles.

At block 660, the controller may define a firing mask (e.g., firing mask 115) so that the actuators corresponding to the subset of nozzles are instructed to propel the printing composition with a higher energy level than the other nozzles (e.g., second subset 130) from the array of nozzles. In some examples, the firing mask comprises an inverted ramp (see, e.g., FIG. 3C) corresponding at least to the determined subset of nozzles.

At block 680, the actuators corresponding to the array of nozzles may propel the printing composition based on the defined firing mask.

FIG. 7 is block diagram illustrating an example of a processor-based system 700 to define a firing mask. In some implementations, the system 700 may be or may form part of a printing device, such as a printer (e.g., printing apparatus 100). In some implementations, the system 700 is a processor-based system and may include a processor 710 coupled to a machine-readable medium 720. The processor 710 may include a single-core processor, a multi-core processor, an application-specific integrated circuit (ASIC), a field programmable gate array (FPGA), and/or any other hardware device suitable for retrieval and/or execution of instructions from the machine-readable medium 720 (e.g., instructions 722, 724, and 726) to perform functions related to various examples. Additionally, or alternatively, the processor 710 may include electronic circuitry for performing the functionality described herein, including the functionality of instructions 722, 724 and/or 726. With respect of the executable instructions represented as boxes in FIG. 7, it should be understood that part or all of the executable instructions and/or electronic circuits included within one box may, in alternative implementations, be included in a different box shown in the figures or in a different box not shown.

The machine-readable medium 720 may be any medium suitable for storing executable instructions, such as a random-access memory (RAM), electrically erasable programmable read-only memory (EEPROM), flash memory, hard disk drives, optical disks, and the like. In some example implementations, the machine-readable medium 720 may be a tangible, non-transitory medium, where the term “non-transitory” does not encompass transitory propagating signals. The machine-readable medium 720 may be disposed within the processor-based system 700, as shown in FIG. 7, in which case the executable instructions may be deemed “installed” on the system 700. Alternatively the machine-readable medium 720 may be a portable (e.g., external) storage medium, for example, that allows system 700 to remotely execute the instructions or download the instructions from the storage medium. In this case, the executable instructions may be part of an “installation package”. As described further herein below, the machine-readable medium may be encoded with a set of executable instructions 722-726.

The machine-readable medium 720 is to receive a print job 730 to be printed using a water-based ink, i.e. printing fluid. Instructions 722, when executed by the processor 710, may cause the processor 710 to identify a plurality of nozzles (e.g., first subset 120) located at a vicinity of an edge of an array of nozzles (e.g., array of nozzles 115), each nozzle having an actuator to eject the water-based ink. Instructions 724, when executed by the processor 710, may cause the processor 710 to define a firing mask (e.g., firing mask 115) to cause the actuators corresponding to the plurality of nozzles to eject the water-based ink with a higher energy level than the actuators corresponding to the other nozzles (e.g., second subset 130) from the array of nozzles. In some examples, the firing mask comprises an inverted ramp (see, e.g., FIG. 3C) corresponding at least to the plurality of nozzles. Instructions 726 when executed by the processor 710, may cause the processor 710 to eject the water-based ink from the array of nozzles based on the firing mask.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processors, or a combination thereof.

As used herein, the terms “about” and “substantially” may be used to provide flexibility to a numerical range endpoint by providing that a given value may be, for example, an additional 20% more or an additional 20% less than the endpoints of the range. The degree of flexibility of this term can be dictated by the particular variable and would be within the knowledge of those skilled in the art to determine based on experience and the associated description herein. In some examples herein, the terms “about” and “substantially” may be used to provide flexibility to a relative position and/or an absolute position.

FIGS. 2, 5, and 6 are flowcharts of an example methods 200, 500, and 600 respectively. These methods may be described as being executed or performed by a controller, such as the controller 140 of FIG. 1. The methods may be implemented in the form of executable instructions stored on a machine-readable storage medium and executed by a single processor or a plurality of processors, and/or in the form of any electronic circuitry, for example digital and/or analog ASIC. In some implementations of the present disclosure, the above methods may include more or less blocks than are shown in FIGS. 2, 5, and 6. In some implementations, some of the blocks of the above methods may, at certain times, be performed in parallel and/or may repeat. As mentioned above, these methods may be performed by a controller (e.g., controller 140 from FIG. 1). In some examples, the controller may be in a printing apparatus. In other examples, the controller may not be included in a printing apparatus.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

Example implementations can be realized according to the following sets of features:

Feature set 1: A printing apparatus comprising:
a printhead including an array of nozzles, each having an actuator to eject a printing fluid, the array of nozzles having a first and a second subset of nozzles, wherein the first subset is located at the vicinity of an edge of the printhead; and
a controller to assign a firing mask so that the actuators corresponding to the first subset of nozzles are instructed to eject the printing fluid with a higher energy level than the actuators corresponding to the second subset of nozzles.

Feature set 2: A printing apparatus with feature set 1, wherein the controller is to:
receive a print job to be printed;
receive a print mode in which the print job is to be printed;
wherein in a first print mode, the controller is to determine a first firing mask based on the print mode in which the first subset of nozzles is to eject the printing fluid at a higher energy level than the second subset of nozzles; and
wherein in a second print mode, the controller is to determine a second firing mask based on the print mode in which the first subset of the array of nozzles is to eject the printing fluid at an equal or lower energy level than the second subset of nozzles.

Feature set 3: A printing apparatus with feature set 1 or 2, wherein the second firing mask is one from the group comprising a ramp mask and a square mask.

Feature set 4: A printing apparatus with any of feature sets 1 to 3, wherein the first firing mask is an inverted ramp mask.

Feature set 5: A printing apparatus with any of feature sets 1 to 4, wherein the controller is further to receive an input indicative that a print job to be printed is to be displayed outdoor; and to select the print mode as the first print mode.

Feature set 6: A printing apparatus with any of feature sets 1 to 5, wherein the controller is further to: receive an input indicative that a print job has high-quality requirements; and select the print mode as the second print mode.

Feature set 7: A printing apparatus with any of feature sets 1 to 6, further comprising a sensor to determine a temperature associated with the first subset of the array of nozzles.

Feature set 8: A printing apparatus with any of feature sets 1 to 7, wherein the controller is further to: receive from the sensor a temperature measurement of at least a part of the first subset of the array of nozzles; determine whether the measured temperature is a lower temperature than a nozzle temperature threshold; and modify the firing mask of the nozzles corresponding to the first subset to increase the energy level in which the first subset of nozzles eject the printing fluid if the measured temperature is a lower temperature than the nozzle temperature threshold.

Feature set 9: A printing apparatus with any of feature sets 1 to 8, wherein the temperature threshold corresponds to a pre-defined temperature associated with a temperature from the second subset of nozzles.

Feature set 10: A printing apparatus with any of feature sets 1 to 9, wherein the controller is to define the firing mask of the nozzles corresponding to the first subset to assign a fire pulse frequency that comprises a value from a range defined from about 8 Hz to about 12 Hz.

Feature set 11: A printing apparatus with any of feature sets 1 to 10, wherein the edge from the array of nozzles is an edge orthogonal with respect to a printing scanning axis.

Feature set 12: A method comprising:
receiving a print job to be printed using an array of nozzles, each nozzle having an actuator to propel a printing composition;
determining a subset of nozzles from the vicinity of an edge of the array of nozzles;
defining a firing mask so that the actuators corresponding to the subset of nozzles are instructed to propel the printing composition with a higher energy level than the other nozzles from the array of nozzles; and
propelling the printing composition based on the defined firing mask.

Feature set 13: A method with feature set 12, wherein the firing mask comprises an inverted ramp corresponding at least to the determined subset of nozzles.

Feature set 14: A non-transitory machine readable medium storing instructions executable by a processor, the medium to receive a print job to be printed using a water-based ink the non-transitory machine-readable medium comprising:
instructions to identify a plurality of nozzles located at a vicinity of an edge of an array of nozzles, each nozzle having an actuator to eject the water-based ink;
instructions to define a firing mask to cause the actuators corresponding to the plurality of nozzles to eject the water-based ink with a higher energy level than the actuators corresponding to the other nozzles from the array of nozzles; and
instructions to eject the water-based ink from the array of nozzles based on the firing mask.

Feature set 15: A non-transitory machine readable medium with feature set 14, wherein the firing mask comprises an inverted ramp corresponding at least to the plurality of nozzles.

What it is claimed is:

1. A printing apparatus comprising:
a printhead including an array of nozzles, each having an actuator to eject a printing fluid, the array of nozzles having a first and a second subset of nozzles, wherein the first subset is located at the vicinity of an edge of the printhead; and
a controller to assign a firing mask so that the actuators corresponding to the first subset of nozzles are instructed to eject the printing fluid with a higher energy level than the actuators corresponding to the second subset of nozzles.

2. The printing apparatus of claim 1, wherein the controller is to:
receive a print job to be printed;
receive a print mode in which the print job is to be printed;
wherein in a first print mode, the controller is to determine a first firing mask based on the print mode in which the first subset of nozzles is to eject the printing fluid at a higher energy level than the second subset of nozzles; and
wherein in a second print mode, the controller is to determine a second firing mask based on the print mode in which the first subset of the array of nozzles is to eject the printing fluid at an equal or lower energy level than the second subset of nozzles.

3. The printing apparatus of claim 2, wherein the second firing mask is one from the group comprising a ramp mask and a square mask.

4. The printing apparatus of claim 2, wherein the first firing mask is an inverted ramp mask.

5. The printing apparatus of claim 2, wherein the controller is further to:
receive an input indicative that a print job to be printed is to be displayed outdoor; and
select the print mode as the first print mode.

6. The printing apparatus of claim 2, wherein the controller is further to:
receive an input indicative that a print job has high-quality requirements; and
select the print mode as the second print mode.

7. The printing apparatus of claim 1, further comprising a sensor to determine a temperature associated with the first subset of the array of nozzles.

8. The printing apparatus of claim 7, wherein the controller is further to:
receive from the sensor a temperature measurement of at least a part of the first subset of the array of nozzles;
determine whether the measured temperature is a lower temperature than a nozzle temperature threshold; and
modify the firing mask of the nozzles corresponding to the first subset to increase the energy level in which the first subset of nozzles eject the printing fluid if the measured temperature is a lower temperature than the nozzle temperature threshold.

9. The printing apparatus of claim 8, wherein the temperature threshold corresponds to a pre-defined temperature associated with a temperature from the second subset of nozzles.

10. The printing apparatus of claim 1, wherein the controller is to define the firing mask of the nozzles corresponding to the first subset to assign a fire pulse frequency that comprises a value from a range defined from about 8 Hz to about 12 Hz.

11. The printing apparatus of claim 1, wherein the edge from the array of nozzles is an edge orthogonal with respect to a printing scanning axis.

12. A method comprising:
receiving a print job to be printed using an array of nozzles, each nozzle having an actuator to propel a printing composition;
determining a subset of nozzles from the vicinity of an edge of the array of nozzles;
defining a firing mask so that the actuators corresponding to the subset of nozzles are instructed to propel the printing composition with a higher energy level than the other nozzles from the array of nozzles; and
propelling the printing composition based on the defined firing mask.

13. The method of claim 12, wherein the firing mask comprises an inverted ramp corresponding at least to the determined subset of nozzles.

14. A non-transitory machine readable medium storing instructions executable by a processor, the medium to receive a print job to be printed using a water-based ink, the non-transitory machine-readable medium comprising:
instructions to identify a plurality of nozzles located at a vicinity of an edge of an array of nozzles, each nozzle having an actuator to eject the water-based ink;
instructions to define a firing mask to cause the actuators corresponding to the plurality of nozzles to eject the water-based ink with a higher energy level than the actuators corresponding to the other nozzles from the array of nozzles; and
instructions to eject the water-based ink from the array of nozzles based on the firing mask.

15. The non-transitory machine readable medium of claim 14, wherein the firing mask comprises an inverted ramp corresponding at least to the plurality of nozzles.
